(19) United States
(12) Patent Application Publication
(10) Pub. No.: US 2017/0008464 A1
(43) Pub. Date: Jan. 12, 2017

(54) COMMUNICATION SYSTEM

(71) Applicant: YAZAKI CORPORATION, Tokyo (JP)

(72) Inventor: Hideaki Kikuchi, Shizuoka (JP)

(21) Appl. No.: 15/201,164

(22) Filed: Jul. 1, 2016

(30) Foreign Application Priority Data
Jul. 8, 2015 (JP) 2015-136901

(51) Int. Cl. B60R 16/02; H04L 29/08; H04L 29/06; H04L 12/66

(52) U.S. Cl. CPC B60R 16/02; H04L 12/66; H04L 67/12; H04L 67/141; H04L 69/08

(57) ABSTRACT

A communication system performs communication between a plurality of devices with different protocols in a vehicle. The communication system includes a plurality of GW units arranged in each of segments of the vehicle and capable of communicating with the plurality of devices with different protocols, and a trunk line connecting the segments with each other. Each of the GW units is connected to two or more devices with different protocols within the same segment, and includes a transmission determination unit and a transmission function unit. When a signal is input from the device being connected, the transmission determination unit determines a device or other gateway units to be a destination of transmission of information. The transmission function unit inputs information transmitted from the transmission determination unit of the other gateway units, and determines the device being a destination of transmission of the input information and transmits the information.

### CROSS-REFERENCE TO RELATED APPLICATION(S)

The present application claims priority to and incorporates by reference the entire contents of Japanese Patent Application No. 2015-136901 filed in Japan on Jul. 8, 2015.

### BACKGROUND OF THE INVENTION

1. Field of the Invention

The present invention relates to a communication system.

2. Description of the Related Art

Conventionally, various communication devices in a vehicle perform communication by transmitting and receiving signals via electrical wires, or the like (refer to Japanese Patent Application Laid-open No. 2012-168922).

With diversification of in-vehicle devices, there is a trend of installing a plurality of communication devices with different protocols in a vehicle. Along with this, it is becoming increasingly common to install a gateway in the vehicle. Since communication between devices with different protocols can always be achieved via a gateway, each of the devices needs to be connected with the gateway. Connecting the plurality of communication devices installed across anterior-posterior portions of the vehicle, with the gateway, however, would generate a problem of the length of an electrical wire needed for the connection.

### SUMMARY OF THE INVENTION

The present invention is made in view of the above-described circumstances, and an object of the present invention is to provide a communication system capable of performing communication even when devices with different protocols are installed, and capable of achieving reduction of electrical wires.

In order to achieve the above mentioned object, a communication system according to one aspect of the present invention performs communication between a plurality of devices with different protocols in a vehicle; and includes a plurality of gateway units each of which being arranged in each of a plurality of segments created by segmenting the vehicle and being capable of communicating with the plurality of devices with different protocols and a trunk line configured to connect the gateway units of the individual segments with each other. Here, each of the gateway units is connected to two or more devices with different protocols within a same segment; and includes a transmission determination unit, configured, in a case where a signal is input from a device to be connected, to determine a device or other gateway unit to be a destination of transmission of information, corresponding to the input signal, and then to transmit the information, and a transmission function unit configured to input information transmitted from the transmission determination unit of the other gateway unit, to determine a device to be a destination of transmission of the input information, and to transmit the information.

The communication system according to the present invention includes a plurality of gateway units, each of which being arranged in each of a plurality of segments created by segmenting a vehicle. Since each of the gateway units is connected to two or more devices within a same segment, it is possible to reduce the length of the electrical wire connecting the gateway unit and each of the devices. Furthermore, there is provided a trunk line to connect the plurality of gateway units to enable transmission and reception of information between each of the gateway units. With this configuration, in a case where a signal from a certain device is input into a specific gateway unit, information is transmitted to another device connected to the specific gateway unit or to another gateway unit, as a result of determination by a transmission determination unit. The information transmitted to another gateway unit is transmitted to a proper device by a transmission function unit of the other gateway unit. With this configuration, it is possible to perform communication even when devices with different protocols are installed, and to reduce the length of the electrical wire.

According to another aspect of the present invention, in the communication system, it is preferable that each of the plurality of gateway units is provided in a power supply control box configured to receive power from a vehicle battery side and distribute the received power to a power-requiring device that requires power supply.

With this communication system, since each of the plurality of gateway units is provided in a power supply control box for distributing power to power-requiring devices that require power supply, it is possible to allow the power supply control box to function as a central unit commonly used for power distribution and communication.

According to still another aspect of the present invention, in the communication system, it is preferable that a voltage received from the vehicle battery side is stepped down by a DC/DC converter in the power supply control box in which the own gateway unit is installed, and supplied to each of the plurality of gateway units.

With this communication system, since voltage received from a vehicle battery side is stepped down by a DC/DC converter in the power supply control box in which the own gateway unit is installed, and supplied to each of the plurality of gateway units, it is possible to reliably obtain operation power supply for the gateway unit by the DC/DC converter in the power supply control box.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration of a communication system according to the present embodiment; and

FIG. 2 is a functional configuration illustrating details of each of gateway units illustrated in FIG. 1.

### DETAILED DESCRIPTION OF THE PREFERRED EMBODIMENTS

Hereinafter, preferred embodiments of the present invention will be described. The present invention is not limited to the following embodiments but can be modified as appropriate without departing from the spirit and scope of the present invention. In the following embodiments, part of configuration and description might be omitted in some cases. For details of the omitted technique, conventional techniques or other techniques well known in the art are understandably applied within a scope that would not conflict with description in the following.

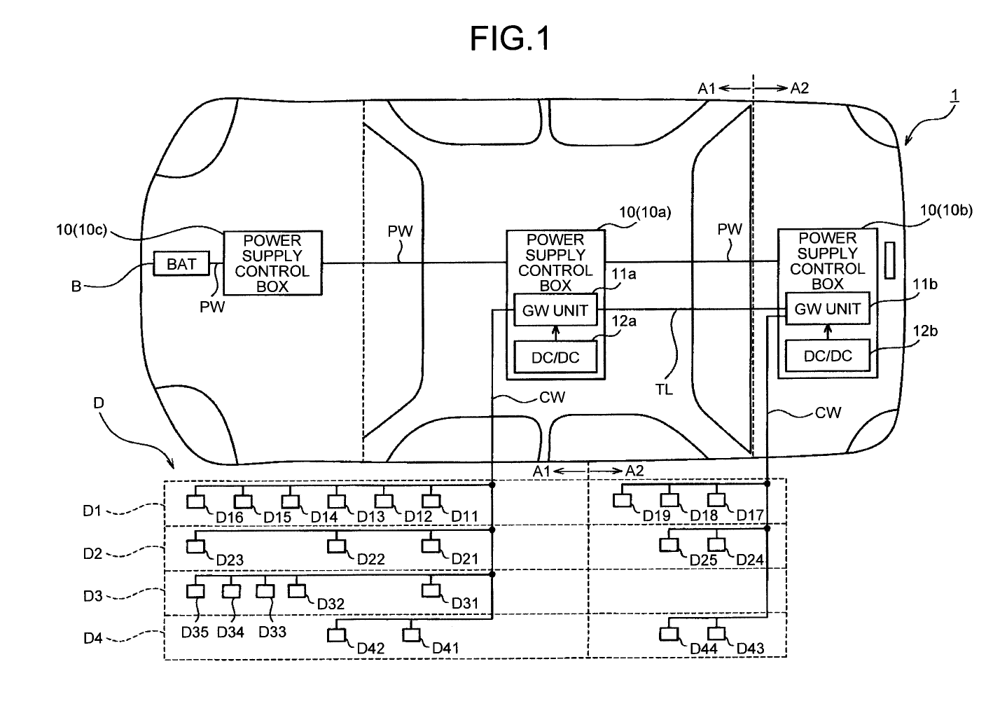

FIG. 1 is a schematic configuration of a communication system 1 according to the present embodiment. As illustrated in FIG. 1, the communication system 1 according to the present embodiment is provided in a vehicle, for performing communication between a plurality of devices D with different protocols, in the vehicle. In the present embodiment, the plurality of devices D has communication capabilities and is divided into a body-system device group D1, a safety-system device group D2, a powertrain-system device group D3, and an entertainment-system device group D4. In addition, as illustrated in FIG. 1, when viewed from above, the vehicle is segmented into two (a plurality of) rectangular segments A1 and A2, the plurality of devices D being distributively arranged in each of the segments A1 and A2. Although the number of segments is two, namely, the first segment A1 and the second segment A2, in the present embodiment, the number of segments is not limited to two, but may be three or more. Hereinafter, the plurality of devices as a whole, or some of the plurality of devices that may belong to any of the groups D1 to D4 will be described with a reference sign D.

The body-system device group D1 includes, for example, first to sixth body-system devices D11 to D16 to be arranged in the first segment A1 on a front and central sides of the vehicle, and a seventh to ninth body-system devices D17 to D19 to be arranged in the second segment A2 on a rear side of the vehicle. Examples of the body-system devices D11 to D19 include a power swing door, a memory seat, an air conditioner, a meter, a shift-by-wire, a lighting device, a rear controller, and a power trunk. Examples of the communication protocol of the body-system device group D1 include CAN (Controller Area Network, 250 kbps to 500 kbps).

The safety-system device group D2 includes first to third safety-system devices D21 to D23 to be arranged in the first segment A1, and a fourth and fifth safety-system devices D24 and D25 to be arranged in the second segment A2. Examples of the safety-system devices D21 to D25 include a yaw rate sensor, an airbag, a wheel-side sensor, and an automatic-drive ECU. Examples of the communication protocol of the safety-system device group D2 include Ethernet (registered trademark) (100 Mbps or above).

The powertrain-system device group D3 includes first to fifth powertrain-system devices D31 to D35 to be arranged in the first segment A1. In the present embodiment, the powertrain-system devices D31 to D35 are not provided in the second segment A2. It is, however, not limited to this, but allowable to provide them in the second segment A2. Examples of the powertrain-system devices D31 to D35 include a hybrid control unit, a steering sensor, an engine, a suspension, a steer-by-wire, a transmission, a battery sensor, and a brake-by-wire. Similarly to the case of the safety-system device group D2, examples of the communication protocol of the powertrain-system device group D3 include Ethernet (100 Mbps or above).

The entertainment-system device group D4 includes first and second entertainment-system devices D41 and D42 to be arranged in the first segment A1, and third and fourth entertainment-system devices D43 and D44 to be arranged in the second segment A2. Examples of the entertainment-system devices D41 to D44 include a navigation apparatus, a display, an amplifier, haptic, and an external communication unit. Examples of the communication protocol of the entertainment-system device group D4 include Ethernet (10 Gbps).

The communication system 1 according to the present embodiment is provided in a vehicle in order to perform communication among the plurality of devices D, and includes a plurality of gateway units (hereinafter, referred to as GW units) 11a and 11b, a trunk line TL, and a connecting wire CW.

Each of the plurality of GW units 11a and 11b is arranged in each of the segments A1 and A2, respectively, and operates as a functional unit capable of communicating with the plurality of devices D with different protocols. Specifically, in the present embodiment, a first GW unit 11a is arranged in the first segment A1 and a second GW unit 11b is arranged in the second segment A2. The trunk line TL is a communication line connecting the GW units 11a and 11b with each other, disposed in the segments A1 and A2, respectively. The connecting wire CW is a communication line connecting each of the GW units 11a and 11b, with the plurality of devices D. In the present embodiment, as clearly illustrated in FIG. 1, each of the GW units 11a and 11b is connected to two or more devices D with different protocols, via the connecting wire CW.

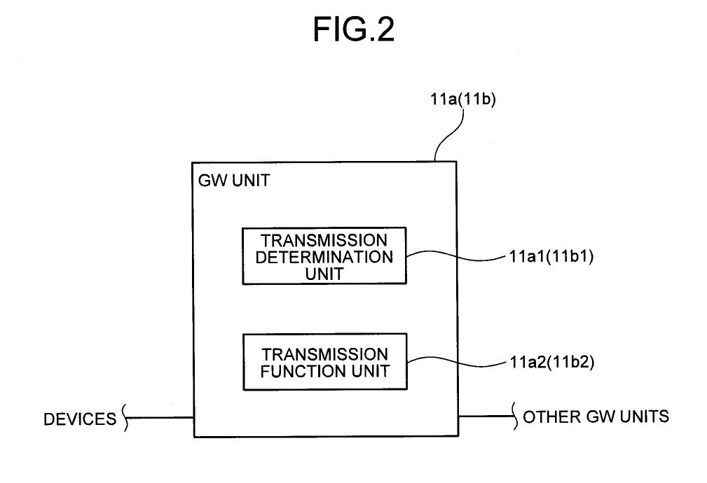

FIG. 2 is a functional configuration illustrating details of each of the GW units 11a and 11b illustrated in FIG. 1. As illustrated in FIG. 2, the GW units 11a and 11b respectively include transmission determination units 11a1 and 11b1 and transmission function units 11a2 and 11b2.

When a signal has been input from the device D connected to the unit, the transmission determination units 11a1 and 11b1 determine either the device D or other GW units 11a and 11b as a destination of transmission of information corresponding to the input signal, and transmits information to the determined destination. The transmission function units 11a2 and 11b2 respectively input information transmitted from the transmission determination units 11a1 and 11b1 of the other GW units 11a and 11b, determine the device D as the destination of transmission of input information, and transmit the information to the determined destination.

Hereinafter, an exemplary case will be described. An exemplary case in which the first GW unit 11a has input a signal from the first body-system device D11 will be discussed. At this time, the transmission determination unit 11a1 of the first GW unit 11a determines whether there is a device D to be a destination of transmission of information corresponding to the input signal. When it is determined that there is the device D as a destination of transmission, the transmission determination unit 11a1 of the first GW unit 11a transmits the information corresponding to the input signal to the device D as a destination of transmission. Here, in a case where information is going to be transmitted to the device D belonging to any of the safety-system device group D2, the powertrain-system device group D3, and the entertainment-system device group D4, the first GW unit 11a performs protocol conversion and transmits the information.

Moreover, the transmission determination unit 11a1 of the first GW unit 11a determines whether there is another GW unit to be a destination of transmission of information corresponding to the input signal. Since there are two GW units 11a and 11b in the present embodiment, the transmission determination unit 11a1 of the first GW unit 11a determines whether to transmit information corresponding to the input signal, to the second GW unit 11b. In this occasion, the transmission determination unit 11a1 of the first GW unit 11a determines whether to transmit information based on information on the device D connected to the second GW unit 11b (namely, the seventh to ninth body-system devices D17 to D19, the fourth and fifth safety-system devices D24 and D25, and the third and fourth entertainment-system devices D43 and D44). This means that the first GW unit 11a stores information on the device D connected to the own unit and information on the device connected to the other GW unit 11b.

Subsequently, in a case where the transmission determination unit 11a1 of the first GW unit 11a determines that it should transmit information corresponding to the input signal to the second GW unit 11b, the transmission determination unit 11a1 transmits the information corresponding to the input signal, to the second GW unit 11b.

In a case where the second GW unit 11b has input the above-described information from the transmission determination unit 11a1 of the first GW unit 11a, the transmission function unit 11b2 of the second GW unit 11b determines the device D to be a destination of transmission of the input information. Then, the transmission function unit 11b2 of the second GW unit 11b transmits information to the device D to be the destination of transmission. Here, in a case where information is going to be transmitted to the device D belonging to any of the safety-system device group D2, the powertrain-system device group D3, and the entertainment-system device group D4, the second GW unit 11b performs protocol conversion and then transmits the information. It is allowable that information for which protocol conversion is completed at the first GW unit 11a is input into the second GW unit 11b.

An example in which a signal is input from the device D connected with the first GW unit 11a has been described. This description may also apply to a case where the signal was input from the device D connected with the second GW unit 11b.

Description will continue referring back to FIG. 1. In the above-described communication system 1, each of the plurality of GW units 11a and 11b is provided in a power supply control box 10. The power supply control box 10 receives power from a vehicle battery B, and distributes the received power to power-requiring devices (not illustrated) that require power supply.

As illustrated in FIG. 1, three (a plurality of) power supply control boxes 10 are provided in a vehicle. Among these, the first and third power supply control boxes 10a and 10c are arranged within the first segment A1, while the second power supply control box 10b is arranged within the second segment A2. The third power supply control box 10c is provided on an engine room side and connected with the vehicle battery B also provided on the engine room side, via a power line PW. The power line PW is also arranged between the third power supply control box 10c and the first power supply control box 10a, and between the first power supply control box 10a and the second power supply control box 10b, so as to connect the boxes with each other. Consequently, the three power supply control boxes 10 receive power from the vehicle battery B via the power line PW. Hereinafter, other than the case where all or any one of the plurality of power supply control boxes are specified, the reference sign will be given simply as the power supply control box 10.

Each of the power supply control boxes 10 distributes power to the power-requiring devices within the same segment A1 or A2. Some of the above-described plurality of devices D correspond to the power-requiring devices. For example, the above-described lighting device, air conditioner, amplifier, display, or the like, correspond to the power-requiring devices. A power window motor, or the like, besides the plurality of devices D, also corresponds to the power-requiring device.

The above-described first and second GW units 11a and 11b are provided in the above-described power supply control box 10. Specifically, the first GW unit 11a is provided in the first power supply control box 10a and the second GW unit 11b is provided in the second power supply control box 10b.

Additionally, the first power supply control box 10a and the second power supply control box 10b include DC/DC converters 12a and 12b, respectively. The voltage received from the vehicle battery B is stepped down by the DC/DC converters 12a and 12b in the power supply control boxes 10a and 10b, in which the own GW unit is installed. The voltage that has been stepped down is supplied to each of the plurality of GW units 11a and 11b. The GW units 11a and 11b are configured, for example, as one functional portion of the CPU, and their exemplary operating voltage is 5 V. Meanwhile, since voltage of the vehicle battery B is assumed to be 12 V or above, it is required to step down the voltage from the vehicle battery B at operation of the GW units 11a and 11b. Accordingly, the first DC/DC converter 12a receives power to be supplied to the first power supply control box 10a via the power line PW, and together with this, steps down the voltage and supplies the power to the first GW unit 11a. Similarly, the second DC/DC converter 12b receives power to be supplied to the second power supply control box 10b via the power line PW, and together with this, steps down the voltage and supplies the power to the second GW unit 11b.

In this manner, with this communication system 1 according to the present embodiment, the two GW units 11a and 11b are arranged respectively in the two segments A1 and A2, created by segmenting the vehicle into two segments, and since each of the GW units 11a and 11b is connected to two or more devices D within the same segment A1 or A2, it is possible to reduce the length of the connecting wire CW that connects the GW units 11a and 11b, with each of the devices D. Furthermore, the trunk line TL to connect the plurality of GW units 11a and 11b is provided so as to enable transmission and reception of information between the GW units 11a and 11b. With this configuration, in a case where a signal from a certain device D is input into the first GW unit 11a, the information is transmitted to another device D connected to the first GW unit 11a or to the second GW unit 11b, as a result of determination of the transmission determination unit 11a1. The information transmitted to the second GW unit 11b is transmitted to a proper device D by the transmission function unit 11b2 of the second GW unit 11b. With this configuration, it is possible to perform communication even when devices D with different protocols are installed, and to reduce the length of the connecting wire CW.

Furthermore, since each of the plurality of GW units 11a and 11b is provided in the power supply control box 10 for distributing power to power-requiring devices that require power supply, it is possible to allow the power supply control box 10 to function as a central unit commonly used for power distribution and communication.

Since voltage from the vehicle battery B side is stepped down by the DC/DC converters 12a and 12b in the power supply control box 10 in which the own GW unit is installed, and supplied to each of the plurality of GW units 11a and 11b, it is possible to reliably obtain operation power supply for the GW units 11a and 11b by the DC/DC converters 12a and 12b in the power supply control box 10.

Hereinabove, the present invention has been described according to embodiments. The present invention is not limited to the above-described embodiments but may be modified within the spirit and scope of the present invention and may be appropriately combined with another technique within a feasible range.

For example, in the present embodiment, the number of provided power supply control boxes 10 is three and the GW units 11a and 11b are arranged in two of the three. It is not, however, limited to this arrangement. It is allowable to arrange such that each of the GW units 11a, 11b and the like is provided in each of all the power supply control boxes 10.

Moreover, the GW units 11a and 11b may be provided not only in the power supply control box 10 but also outside the power supply control box 10. The GW units 11a and 11b may be operated not only by the power supplied from the vehicle battery B via the DC/DC converters 12a and 12b, but also by a dedicated battery, or the like.

According to the present invention, it is possible to provide a communication system capable of performing communication even when devices with different protocols are installed and reducing the length of the electrical wire.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication system for performing communication between a plurality of devices with different protocols in a vehicle, the communication system comprising:
a plurality of gateway units each of which being arranged in each of a plurality of segments created by segmenting the vehicle and being capable of communicating with the plurality of devices with different protocols; and
a trunk line configured to connect the gateway units of the individual segments with each other, wherein
each of the gateway units is connected to two or more devices with different protocols within a same segment, and includes
a transmission determination unit, configured, in a case where a signal is input from a device to be connected, to determine a device or other gateway unit to be a destination of transmission of information corresponding to the input signal, and then to transmit the information, and
a transmission function unit configured to input information transmitted from the transmission determination unit of the other gateway unit, to determine a device to be a destination of transmission of the input information, and to transmit the information.

2. The communication system according to claim 1, wherein
each of the plurality of gateway units is provided in a power supply control box configured to receive power from a vehicle battery side and distribute the received power to a power-requiring device that requires power supply.

3. The communication system according to claim 2, wherein
a voltage received from the vehicle battery side is stepped down by a DC/DC converter in the power supply control box in which the own gateway unit is installed, and supplied to each of the plurality of gateway units.
